(19) United States
(12) Patent Application Publication
(10) Pub. No.: US 2017/0070950 A1
(43) Pub. Date: Mar. 9, 2017

(54) METHOD FOR BSS TRANSITION

(71) Applicants: Gabor Bajko, Santa Clara, CA (US); Chao-Chun Wang, Taipei City (TW); Chih-Shi Yee, Hsinchu County (TW); MEDIATEK INC., Hsin-Chu (TW)

(72) Inventors: Gabor Bajko, Santa Clara, CA (US); Chao-Chun Wang, Taipei City (TW); Chih-Shi Yee, Hsinchu County (TW)

(21) Appl. No.: 15/121,775

(22) PCT Filed: Feb. 26, 2015
(86) PCT No.: PCT/US2015/017612

§ 371 Date: Aug. 26, 2016

Related U.S. Application Data
(60) Provisional application No. 61/945,867, filed on Feb. 28, 2014.

(51) Int. Cl. H04W 48/20; H04W 48/14

(52) U.S. Cl. CPC H04W 48/20; H04W 48/14

(57) ABSTRACT

A method for transiting basic service sets (BSSs) in a wireless communications system is provided. A wireless station first detects an integrity of a real-time flow from an access point in a first BSS. The wireless station then sends a request frame to the access point. The request frame comprises a communication condition of the wireless station. The access point responds with information of a plurality of APs and a set of parameters that used to select the APs. The wireless station then determines which AP to be associated according to the information of the plurality of APs and the communication quality of the wireless station.

### CROSS REFERENCE TO RELATED APPLICATIONS

This application claims priority under 35 U.S.C. §119 from U.S. Provisional Application No. 61/945, 867, entitled “BSS transition for MM STAs,” filed on Feb. 28, 2014, the subject matter of which is incorporated herein by reference.

### TECHNICAL FIELD

The disclosed embodiments relate generally to wireless network communications, and, more particularly, to a transition method in wireless communications systems.

### BACKGROUND

In a wireless communications network, when a station (STA) with an active multimedia (MM) session experiences degrading link/radio conditions, conventionally, the STA can perform a scanning in other channels to identify an AP that the STA could get better service from, for the STA's MM session. The STA would look at parameters such as channel utilization, available admission capacity, basic service set (BSS) Average Access Delay, RSSI, RCPI, etc. between the STA and the candidate APs, to decide which AP to associate with. However, leaving the current channel with an ongoing MM session to scan other channels would potentially further degrade the MM session quality.

Another conventional method is that the STA waits to receive from the access point (AP) a BSS Transition Management Request frame that includes candidate APs, and then connect to one of the APs suggested. However, there is no way for the STA to evaluate whether the suggested APs can provide a better service than the current AP.

In another conventional scenario, a STA connected to an AP which serves well during its MM session, may need to switch to another APs when the user at the STA wants to change from standard to HD resolution. The STA can therefore actively generates a BSS Transition Management Query frame to request the AP to send a BSS Transition Management Request frame with candidate APs. However, the STA still can't decide whether any of the candidate APs can provide a better service than the current AP.

It is thus desirable to have a method for the STA to transit to another AP that provides a better service.

### SUMMARY

A method of transiting BSS in a wireless communications system is provided. A wireless station detects an integrity of a real-time flow from a first wireless device. The wireless station then sends a request frame to the wireless device, and the request frame comprises a communication condition of the wireless station. The wireless device than sends information of a plurality of wireless devices. The information comprises a set of parameters that the wireless devices uses to select the plurality of wireless devices. The wireless station then associates with one of the plurality of wireless devices according to the information of the plurality of wireless devices and the communication condition of the wireless station.

In one example, the wireless station transits from the first wireless device to another wireless device without interrupting a reception of multimedia frames.

Another method of transiting BSS in a wireless communications system is also provided. A wireless device, such as an access point, receives a request frame from a wireless station. The request frame comprises a communication condition detected by the wireless station. The wireless device then sends information of a plurality of wireless devices to the wireless station while the information comprises a set of parameters that the wireless device used to select the plurality of wires devices. The wireless device then disassociates with the wireless station such that the wireless station can associate with one of the plurality of wireless devices according to the information of the plurality of wireless devices and the communication condition of the wireless station.

Other embodiments and advantages are described in the detailed description below. This summary does not purport to define the invention. The invention is defined by the claims.

### BRIEF DESCRIPTION OF THE DRAWINGS

FIG. 1 illustrates a wireless communications system in accordance with a novel aspect.

FIG. 2 is a diagram of a method in accordance with a novel aspect.

### DETAILED DESCRIPTION

Reference will now be made in detail to some embodiments of the invention, examples of which are illustrated in the accompanying drawings.

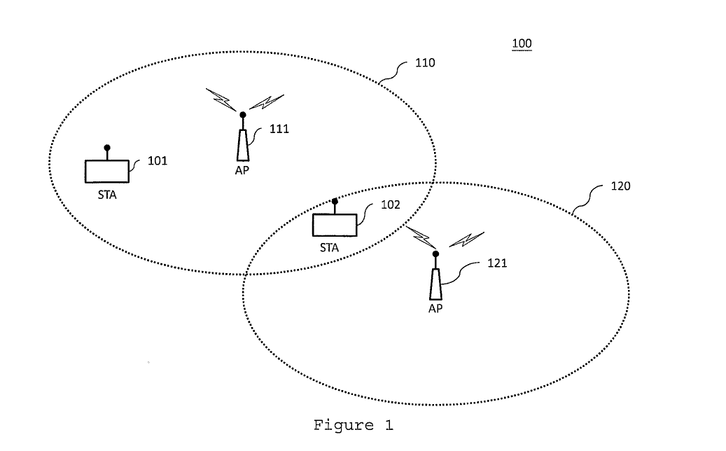

FIG. 1 illustrates a wireless communications network 100 in accordance with a novel aspect. The wireless communications network 100 comprises a first basic service set BSS 110 forms by a first wireless device, such as an access point AP 111, a second BSS 120 forms by a second wireless device, such as an access point AP 121, and a station STA 101 within the first BSS 110. The access points here can be referred to a conventional access point or a station operating in an access point mode.

The STA 101 is first associated with the first access point AP 111 according to IEEE 802.11 standard. However, this is exemplary and is not limited thereto. According to an embodiment of the present invention, the STA 101 operates in a multimedia (MM) session, e.g. transmits/receives packets with multimedia content, with the first AP 111. However, the STA 101 can transmit any kind of frame and is still within the scope of the present invention.

During the exemplary multimedia session with the first AP 111, the STA 101 is able to detecting an integrity of a real-time flow from the first AP 111, by, for example, estimating the bandwidth and delay requirements of the MM session. The detection can be also performed before the MM session starts. Moreover, the STA 101 is able to monitor the link conditions during the MM session and realize when the quality degrades to a point that the STA 101 should consider to transit to another AP.

In a novel aspect, the STA 101 detects a degradation of channel between the STA 101 and the AP 111, the STA 101 may have to transit or switch to another access point to get a better communication quality.

In another novel aspect, a user at the STA 101 may decide to change the multimedia to a higher resolution, and therefore needs more bandwidth for the communication between the STA 101 and the AP 111. Hence, the STA 101 may also decide to switch or to transit to another access point to make sure the multimedia can be smoothly presented.

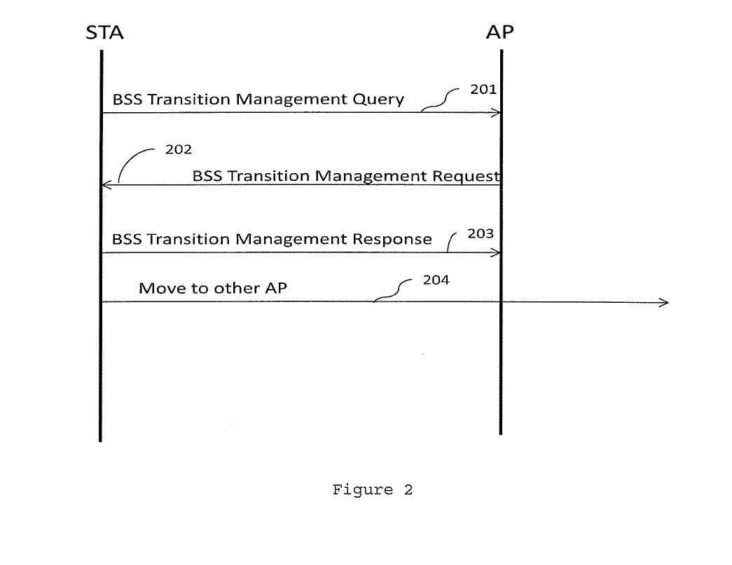

Please refer to FIG. 2 which illustrates a method of the present invention. According to at least the above aspects, the STA 101 realizes that change of AP would be required, so the STA 101 therefore sends a BSS Transition Management Query frame 201. In other words, the STA 101 initiates a transition to another access point.

STA 101 includes a communication condition of itself into the BSS Transition Management Query frame. This frame may comprise a list of channels that is not preferred by the STA 101. Also, the frame may comprise a local interference condition of the STA 101. This is to indicate to the AP 111 about the condition of the STA 101 and also the channels that the AP 111 should not take into account for transition.

AP 111 then responds to the Query with a BSS Transition Management Request frame 202, and provides information of a plurality of APs, such as a list of candidate APs. However, the APs in the list of candidate APs may operate in the channels that are not preferred by the STA 101, or the APs in the list of candidate APs may not present due to lack of updated information. So the AP 111 of the present invention informs the STA 101 on what information does the AP 111 bases on to provide the list of candidate APs. In other words, the AP 111 provides a set of parameters that can be used to select the candidate APs. The STA 101 does not need to make a blind decision as a conventional station. In one novel aspect, the BSS Transition Management Request frame may comprise an add traffic stream (ADDTS) request or a multimedia quality of service (QoS) request.

For example, when the AP 111 includes the BSS Transition Candidate list, neighbor report elements can also be included, such as the parameters that may be essential for the MM session, for example, the neighbor report comprises at least one of, timing synchronization function (TSF) information, condensed country string, basic service set (BSS) transition candidate preference, BSS termination duration, bearing, high throughput (HT) capabilities, HT operation, secondary channel offset, measurement pilot transmission, radio measurement (RM) enabled capabilities, multiple BSSID, vendor specific field, BSS loading, BSS average access delay, and BSS access delay.

The information of a plurality of APs that provided by the AP 111 may be collected from a station that is previously in another BSS and then transits to the current BSS. Or, the information can be obtained from backend network that the AP 111 is connected to. However, the present invention is not limited to the examples given herein and any methods that can provide the information of a plurality of APs to the AP 111 can be applied.

When the STA 101 receives the BSS Transition Management Request frame 202, the STA 101 can evaluate by itself to see if any of the candidate APs have better conditions to handle the MM session according to the set of parameters. In other words, the STA 101 may double check the list of candidate APs, and determine whether it makes sense to transition or not.

STA 101 would send a BSS Transition Management Response 203 back to the AP, according to the current IEEE 802.11 standard, and let the AP know what it is going to do. If the STA 101 does not find an AP that can provide better service, the STA 101 may decide to stay in the current BSS 110 and keep the association with the AP 111.

So the current serving AP 111 according to the present invention is able to assist the STA 111 in the transition, by providing not only a list of candidate APs, but also the value of the parameters which need to be taken into account for the STA's MM session to improve if it is transitioning to a new AP.

In one novel aspect, if the STA 101 has a beacon report available at the time of placing the BSS Transition management Query, the STA 101 could include that into the frame.

According to another embodiment of the present invention, the STA 111 can also send the BSS transition management query to another access point if the STA 111 is covered in an overlapped BSS (OBSS) area. Please again refer to FIG. 1, since STA 102 is located in an area that is covered by both the BSS 110 that is formed by the AP 111 and the BSS 120 that is formed by the AP 121, the STA 101 may send the BSS transition management query to the AP 121 according to the above embodiments, and the AP 121 may respond according to the above embodiments, too.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising,
detecting an integrity of a real-time flow from a first wireless device by a wireless station;
sending a request frame by the wireless station, wherein the request frame comprises a communication condition of the wireless station;
receiving information of a plurality of wireless devices by the wireless station, wherein the information comprises a set of parameters; and
associating the wireless station with one of the plurality of wireless devices according to the information of the plurality of wireless devices and the communication condition of the wireless station.

2. The method of claim 1, further comprising,
transmitting/receiving multimedia frames by the wireless station with the first wireless device.

3. The method of claim 2, wherein the step of transmitting/receiving multimedia frames is not interrupted when associating the wireless station with one of the plurality of wireless devices.

4. The method of claim 1, wherein the detecting step comprises,
detecting a degradation of a channel between the wireless station and the first wireless device.

5. The method of claim 1, wherein the communication condition of the wireless station comprises interference information and at least one undesired channel of the wireless station.

6. The method of claim 1, wherein the request frame further comprises an add traffic stream (ADDTS) request or a multimedia quality of service (QoS) request.

7. The method of claim 1, wherein the information of a plurality of wireless devices comprises a candidate list and the set of parameters comprises a neighbor report.

8. The method of claim 7, wherein the neighbor report comprises at least one of, timing synchronization function (TSF) information, condensed country string, basic service set (BSS) transition candidate preference, BSS termination duration, bearing, high throughput (HT) capabilities, HT operation, secondary channel offset, measurement pilot transmission, radio measurement (RM) enabled capabilities, multiple BSSID, vendor specific field, BSS loading, BSS average access delay, and BSS access delay.

9. The method of claim 1, wherein the first wireless device forms a first basic service set (BSS).

10. The method of claim 1, wherein the received information of the plurality of wireless devices is from the first wireless device or a second wireless device, wherein the second wireless device forms a second basic service set.

11. A method, comprising,
receiving a request frame by a wireless device from a wireless station, wherein the request frame comprises a communication condition detected by the wireless station;
sending information of a plurality of wireless devices to the wireless station by the wireless device, wherein the information comprises a set of parameters that the wireless device used to select the plurality of wires devices; and
disassociating with the wireless station by the wireless device such that the wireless station can associate with one of the plurality of wireless devices according to the information of the plurality of wireless devices and the communication condition of the wireless station.

12. The method of claim 11, wherein the wireless device forms a basic service set.

13. The method of claim 11, further comprising,
transmitting/receiving multimedia frames by the wireless device to the wireless station.

14. The method of claim 11, wherein the request frame further comprises an add traffic stream (ADDTS) request or a multimedia quality of service (QoS) request.

15. The method of claim 11, wherein the information of a plurality of wireless devices comprises a candidate list and the set of parameters comprises a neighbor report.

16. The method of claim 15, wherein the neighbor report comprises at least one of, timing synchronization function (TSF) information, condensed country string, basic service set (BSS) transition candidate preference, BSS termination duration, bearing, high throughput (HT) capabilities, HT operation, secondary channel offset, measurement pilot transmission, radio measurement (RM) enabled capabilities, multiple BSSID, vendor specific field, BSS loading, BSS average access delay, and BSS access delay.

17. A wireless communications system, comprising,
a first wireless device that forms a first basic service set;
a wireless station associated with the wireless device, wherein the wireless station performs the following steps,
detecting an integrity of a real-time flow from the first wireless device;
sending a request frame, wherein the request frame comprises a communication condition of the wireless station;
receiving information of a plurality of wireless devices, wherein the information comprises a set of parameters; and
associating with one of the plurality of wireless devices according to the information of the plurality of wireless devices and the communication condition of the wireless station.

18. The wireless communications system of claim 17, wherein the information of a plurality of wireless devices comprises a candidate list and the set of parameters comprises a neighbor report.

19. The wireless communications system of claim 18, wherein the neighbor report comprises at least one of, timing synchronization function (TSF) information, condensed country string, basic service set (BSS) transition candidate preference, BSS termination duration, bearing, high throughput (HT) capabilities, HT operation, secondary channel offset, measurement pilot transmission, radio measurement (RM) enabled capabilities, multiple BSSID, vendor specific field, BSS loading, BSS average access delay, and BSS access delay.

20. The wireless communications system of claim 17, wherein the received information of the plurality of wireless devices is from the first wireless device or a second wireless device, wherein the second wireless device forms a second basic service set.
